(19) United States
(12) Patent Application Publication
(10) Pub. No.: US 2022/0029653 A1
(43) Pub. Date: Jan. 27, 2022

(54) TACTILE WEARABLE

(71) Applicant: Peter IDESTAM-ALMQUIST, Solna (SE)

(72) Inventor: Peter IDESTAM-ALMQUIST, Solna (SE)

(21) Appl. No.: 17/297,031

(22) PCT Filed: Nov. 28, 2019
(86) PCT No.: PCT/EP2019/082887

§ 371 Date: May 26, 2021

(51) Int. Cl. H04B 1/3827; G06F 3/01; G06F 1/16; H04M 1/72412; H04M 1/72436

(52) U.S. Cl. CPC H04B 1/385; G06F 3/016; H04M 1/72436; H04M 1/72412; G06F 1/163

(57) ABSTRACT

A tactile wearable device in a communication system, the tactile wearable device comprising: at least two switches arranged to receive first tactile information from user in a sequence, at least two tactile actuators arranged to provide second tactile information to a user in a sequence, and wireless communication means arranged to transmit information to and from a wireless device.

### TECHNICAL FIELD

The invention relates to a system and a method of a tactile wearable device.

### BACKGROUND

Wireless devices, such as a mobile phones, smartphones, smartwatches, smart speakers, smart TVs, tablets and laptops, output information to users mainly via displays or speakers, and do not make much use of the tactile sense. Such devices get input information mainly via keyboards, keypads, touchable displays or microphones, and do not make use of tactile input in the form of tapping patterns.

Current solutions are usually able to send a simple vibrating alert to supplement the ring tone, but not to convey any advanced information. There are also some available solutions able to transmit more than a simple vibrating alert to the user, the scope of information they are able to transmit is limited.

### SUMMARY

It is an objective for users to be able to receive or transmit information from their wireless devices in any situation, even when using a display, a speaker; a keyboard, a touchable display or a microphone is not appropriate or possible, e.g. quiet or dark areas like libraries or cinemas; or noisy or very light areas like in a vicinity of a machinery or on a very sunny day; or when the users do not want people around them to be able to perceive the information. It is an objective to provide communication means for users not able to fully use the usual ways of outputting information from a wireless device, e.g. visually or hearing impaired. It is an objective to provide a solution where a user can receive and transmit messages by use of a tactile sense.

A first aspect of the invention is a tactile wearable device in a communication system, the tactile wearable device comprising:
at least two switches arranged to receive first tactile information by means of tapping patterns from a user in a sequence, the first tactile information comprising different types of signals for each switch,
at least two tactile actuators arranged to provide second tactile information to a user in a sequence,
a first mapping table arranged to convert the received first tactile information into first internal information and to convert second internal information into second tactile information, and
   wherein the tactile wearable device is arranged to transmit via a wireless communication means the first internal information to a wireless device and to receive the second internal information from a wireless device.

In an embodiment, the two switches are pushbuttons or buttons on a touchable display.

In an embodiment, the two tactile actuators are linear resonant actuators.

In an embodiment, the wireless communication means is a Bluetooth wireless connection.

A second aspect of the invention is a wireless communication system comprising a tactile wearable device according to first aspect, and a wireless device arranged to receive first internal information from the tactile wearable device, transmit first textual information to a second wireless device, transmit second internal information to a tactile wearable device, and receive second textual information from the second wireless device, wherein the wireless device comprises a second mapping table arranged to convert the received first internal information into first textual information and to convert second textual information into second internal information.

In an embodiment, the first or the second textual information is presented in a SMS, e-mail or as a push notification.

In an embodiment, the first or the second mapping table is set-up by pre-determined rules.

In an embodiment, the first or the second mapping table is set-up by a user.

A third aspect of the invention is a method for exchanging information using a tactile wearable device in a communication system, the method comprising: receiving tactile information as different types of signals from a user by means of tapping patterns in a sequence by using at least two switches of the tactile wearable device; retrieving, from a first mapping table of the tactile wearable device, the corresponding translation of the tactual information as a first internal information, transmitting the first internal information from the tactile wearable device to a wireless device via wireless communication means, retrieving, from a second mapping table of the wireless device, the corresponding translation of the first internal information as a first textual information, receiving a second textual information from the second wireless device, or by producing the second textual information in the wireless device; retrieving, from a second mapping table of the wireless device, the corresponding translation of the second textual information as a second internal information, communicating the second internal information from the wireless device to the tactile wearable device via wireless communication means, retrieving, from a first mapping table, the corresponding translation of the second internal information to the second tactile information, transmitting the received second tactile information through the at least two tactile actuators to the user.

In an embodiment, the first textual information is sent to a second wireless device.

In a further embodiment, a computer program or a computer program product comprising a computer-readable medium, comprises instructions, which when executed by a processor, cause the processor to perform the method described in the third aspect.

### BRIEF DESCRIPTION OF THE DRAWINGS

The invention is now described, by way of example, with reference to the accompanying drawings, in which:

FIG. 1 illustrates the embodiment of a communication system 100 comprising a tactile wearable device 10 and a wireless device 50.

FIG. 2a illustrates the method of transmitting information from a tactile wearable device 10.

FIG. 2b illustrates the method of transmitting information to a tactile wearable device 10.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

The invention has mainly been described above with reference to a few embodiments. However, as is readily appreciated by a person skilled in the art, other embodiments than the ones disclosed above are equally possible within the scope of the invention, as defined by the appended patent claims.

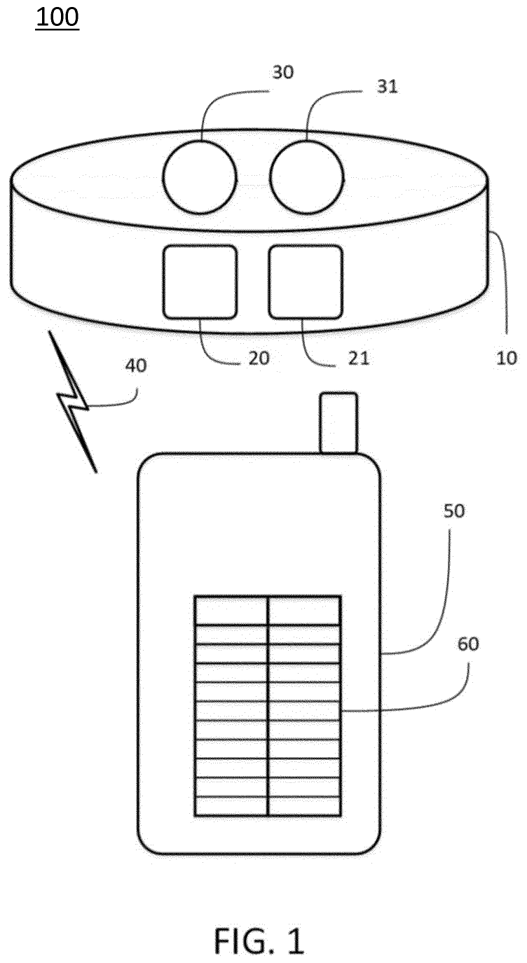

FIG. 1 illustrates the tactile wearable device 10 in a communication system 100. The tactile wearable device is a wearable computer in form of a wristwatch, wristband, bracelet, necklace, anklet, headband, or any other wearable computer device placed on a user so the user is able to receive and transmit tactile information, such as tapping patterns.

The tactile wearable device 10 comprises at least two switches 20, 21 arranged to receive first tactile information 110 from a user in a sequence and at least two tactile actuators 30, 31 arranged to provide second tactile information 122 to a user in a sequence.

The tactile information 110, 122 can be a Morse code, but instead of a traditional coding by one switch, with “dots”, such as short signals and “dashes” such as long signals being distinguished only by the length of the signal, the two types of signals are received as a tactile information 110 by two different switches 20, 21, or transmitted as a tactile information 122 by two different actuators 30, 31. The discrete difference between the two types of signals, instead of a continuous one provides an improved usability.

The at least two actuators 30, 31 can be linear resonant actuators, piezo-electric actuators, eccentric rotating mass actuators or any other type of appropriate actuators. The tactile information 122 transmitted by at least two actuators 30, 31 can be a pressure, vibration, motion, or any other type of output appropriate to be sensed by a human skin.

The at least two switches 20, 21 are any kind of electrical components that can open or close an electrical circuit, interrupting the current. The switches can be any kind of push buttons made of plastic, metal or any other appropriate material and shape; or touch sensitive buttons, e.g. buttons on a capacitive touchable display; or accelerometers so they can easily be activated by a human movement or pressure.

The tactile wearable device 10 also comprises a wireless communication means 40, e.g. Bluetooth, arranged to transmit the first internal information 111 to a wireless device 50 and to receive the second internal information 121 from the wireless device 50. The wireless device 50 can be any kind of computing device, such as a mobile phone, smartphone, smartwatch, smart speaker, smart TV, tablet or laptop.

The tactile wearable device 10 comprises a wireless communication means 40, e.g. Bluetooth, and a first mapping table 15, not disclosed on figures. The first mapping table is arranged to convert the received first tactile information 110 into first internal information 111 and to convert second internal information 121 into second tactual information 122.

The internal information 111, 121 received or transmitted between the wearable 10 and the wireless device 50 is not communicated via tactile means, e.g. switches and actuators, but via wireless communication means 40 as a digital signal.

The wireless device 50 comprises a second mapping table 60. The second mapping table is arranged to convert the received first internal information 111 into first textual information 112 and to convert received or produced second textual information 120 into second internal information 121.

The arrangement of any of the mapping tables 15, 60 can be pre-determined or arranged by the user in the wireless device 50. For example, instead of using three short signals to be corresponds to the alphanumerical character, letter “S”, as usually performed in the Morse code, a user may arrange the mapping tables for three short signals to be corresponding to a word “yes” or even an information from their alarm clock. The textual information is comprised of alphanumerical characters sent as an electronic message over a cellular network or an Internet connection, as a SMS, e-mail or any kind of a push notification.

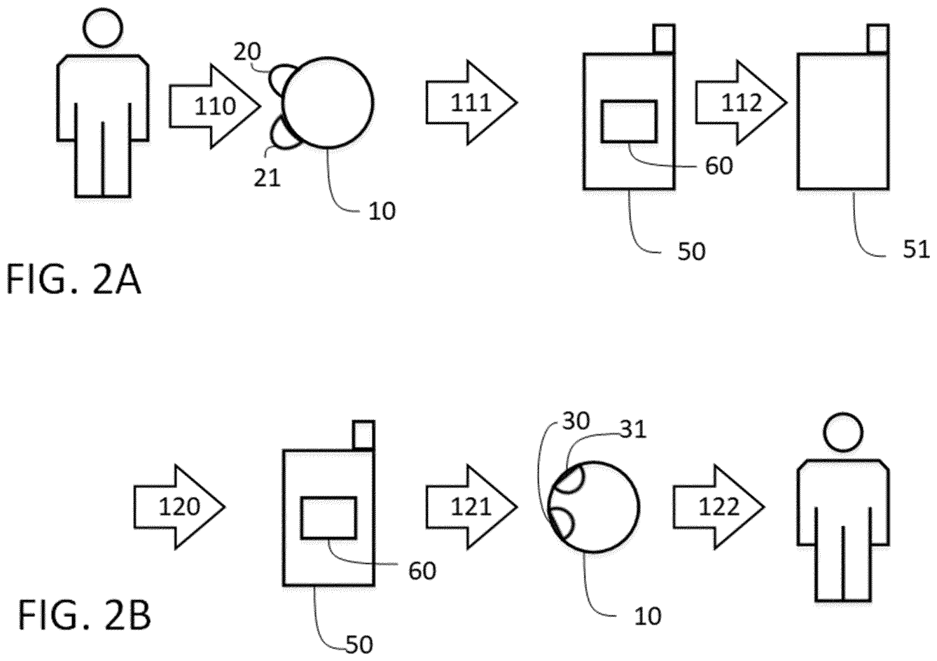

FIG. 2a illustrates the method for transmitting information from a tactile wearable device 10 in a communication system 100. The tactile wearable device 10 receives first tactile information 110 from a user in a sequence by at least one of the two switches 20, 21 of the tactile wearable device 10. This received first tactile information 110 from the tactile wearable device 10 is converted into first internal information 111 by a first mapping table 15, not disclosed on figures, and then communicated to a wireless device 50 via wireless communication means 40. The corresponding translation of the first internal information 111 to the first textual information 112 is retrieved from the second mapping table 60. The first textual information 112 may be sent to a second wireless device 51 from the first wireless device 50.

FIG. 2b illustrates the method for transmitting information to a tactile wearable device 10 in a communication system 100. The wireless device 50 may receive from a second mobile device 51 or produce by itself e.g. triggered by an alarm clock, reminder, low battery status or any other event in the wireless device, a second textual information 120. This information 120 is translated to the second internal information 121 by retrieving the corresponding translation from the second mapping table 60. The second internal information 121 is communicated from the wireless device 50 to the tactile wearable device 10 via wireless communication means 40 and then translated by a first mapping table 15, not disclosed on figures, of the tactile wearable device, to the second tactile information 122. Then, the two tactile actuators 30, 31 comprised in the tactile wearable device 10 provide the second tactile information 122 to the user.

The described methods may be implemented as a computer program stored on a computer program product. The computer program is executed by a computer comprising a memory for storing the instructions and a processor for processing the instructions of the computer program executed by the computer.

The invention according to the present disclosure is not limited to the embodiment shown in the figures. For example, a first mapping table 15 in the tactile wearable device 10 is not shown in the figures. Furthermore, the tactile wearable device 10, the switches 20, 21 and the actuators 30, 31 need not necessarily to be of the shape, number or the position as shown on figures. The tactile wearable device 10, the switches 20, 21, and the actuators 30, 31 may be arranged in any manner which would allow for a user to transmit the first tactile information 110 and to receive the second tactile information 112 in an appropriate manner. Furthermore, the second textual information 120 does not have to be received by a wireless device 50 as shown on FIG. 2b, but it can be produced in the wireless device 50 itself.

1. A tactile wearable device a communication system, the tactile wearable device comprising:
at least two switches arranged to receive first tactile information by means of tapping patterns from a user in a sequence, the first tactile information comprising different types of signals for each switch,
at least two tactile actuators arranged to provide second tactile information to a user in a sequence,
a first mapping table arranged to convert the received first tactile information into first internal information and to convert second internal information into second tactile information, and
wherein the tactile wearable device is arranged to transmit via a wireless communication means the first internal information to a wireless device and to receive the second internal information from a wireless device.

2. The tactile wearable device according to claim 1, wherein the at least two switches are pushbuttons or buttons on a touchable display.

3. The tactile wearable device according to claim 1, wherein the two tactile actuators are linear resonant actuators.

4. The tactile wearable device according to any of the preceding claim 1, wherein the wireless communication means is a Bluetooth wireless connection. 5, (Currently Amended) A wireless communication system comprising:
a tactile wearable device according to claim 1,
a wireless device arranged to:
receive first internal information from the tactile wearable device,
transmit first textual information to a second wireless device,
transmit second internal information to a tactile wearable device, and
receive second textual information from the second wireless device,
wherein the wireless device comprises a second mapping table arranged to convert the received first internal information into first textual information and to convert second textual information into second internal information.

6. The wireless communication system according to claim 5, wherein the first or the second textual information is presented in a SMS, e-mail or as a push notification.

7. The wireless communication system according to claim 5, wherein the first or the second mapping table is set-up by pre-determined rules.

8. The wireless communication system according to claim 5, wherein the first or the second mapping table is set-up by a user.

9. A method for exchanging information using a tactile wearable device in a communication system the method comprising:
receiving tactile information as different types of signals from a user by means of tapping patterns in a sequence by using at least two switches of the tactile wearable device;
retrieving, from a first mapping table of the tactile wearable device, the corresponding translation of the tactual information as a first internal information, transmitting the first internal information from the tactile wearable device to a wireless device via wireless communication means,
retrieving, from a second mapping table of the wireless device, the corresponding translation of the first internal information as a first textual information
receiving a second textual information from the second wireless device, or by producing the second textual information in the wireless device; retrieving, from a second mapping table (of the wireless device, the corresponding translation of the second textual information as a second internal information, communicating the second internal information from the wireless device to the tactile wearable device via wireless communication means,
retrieving, from a first mapping table, the corresponding translation of the second internal information to the second tactile information, transmitting the received second tactile information through the at least two tactile actuators to the user.

10. A computer program comprising instructions which, when executed by a processor, cause the processor to perform the method of claim 9.

11. A computer program product comprising a computer-readable medium comprising instructions which, when executed by a processor, cause the processor to perform the method of claim 9.
